(19) United States
(12) Patent Application Publication
(10) Pub. No.: US 2025/0313979 A1
(43) Pub. Date: Oct. 9, 2025

(54) SYSTEMS AND METHODS OF RECYCLING ALUMINUM SCRAP AND ASSOCIATED PRODUCTS

(71) Applicant: ALCOA USA CORP., Pittsburgh, PA (US)

(72) Inventors: Xinghua Liu, Murrysville, PA (US); Andrew L. Schnitgen, Mars, PA (US); Francis Caron, Quebec (CA)

(21) Appl. No.: 19/241,747

(22) Filed: Jun. 18, 2025

Related U.S. Application Data
(63) Continuation of application No. PCT/US2024/010467, filed on Jan. 5, 2024.
(60) Provisional application No. 63/437,251, filed on Jan. 5, 2023.

(51) Int. Cl. C25C 1/02; C22C 1/00

(52) U.S. Cl. CPC C25C 1/02; C22C 1/00

(57) ABSTRACT

New products and methods related to aluminum scrap recycling are disclosed. In one embodiment, a method includes (a) adding a feedstock to an aluminum purification cell, (b) purifying the feedstock, thereby producing a purified aluminum stream and a raffinate stream, (c) separating components of the raffinate stream, thereby producing at least a first byproduct stream and a second byproduct stream, and (d) mixing at least a portion of the first byproduct stream with at least a portion of the purified aluminum from the purified aluminum stream to produce an aluminum alloy product.

### CROSS-REFERENCE TO RELATED APPLICATION

This application is a continuation of International Patent Application No. PCT/US2024/010467, entitled “Systems and Methods of Recycling Aluminum Scrap and Associated Products,” filed Jan. 5, 2024, which claims priority to U.S. Provisional Patent Application No. 63/437,251, entitled “Systems and Methods of Recycling Aluminum Scrap and Associated Products,” filed Jan. 5, 2023. Each of the above-identified patent applications is hereby incorporated by reference in its entirety.

### BACKGROUND

Aluminum metal has been traditionally made by converting alumina (Al₂O₃), which typically originates from bauxite ore. The conversion of alumina to aluminum is typically carried out in an electrolytic cell by passing an electric current through an electrolyte having alumina and cryolite. Carbon from the carbon anode reacts with the oxygen component in the alumina to produce carbon dioxide, which is expelled from the cell, leaving molten aluminum as a by-product. The molten aluminum gathers on the bottom of the electrolytic cell and is subsequently removed as relatively pure metallic aluminum. Various efforts have been made to purify metallic aluminum, including the “Hoopes process” (see U.S. Pat. No. 1,534,315) as well as those methods described in commonly owned international patent application WO2016/130823.

### SUMMARY OF THE DISCLOSURE

Broadly, the present disclosure relates to methods and systems for purifying aluminum scrap in an aluminum purification cell, and products made therefrom. Continuous accumulation of impurities in aluminum scrap may present a challenge for aluminum recycling. In some instances, the recycled aluminum scrap may only be used in products that require lower and lower amounts of aluminum. The “down-cycling” into lower value products results in products with reducing amounts of purity—an unsustainable process. Although aluminum is highly recyclable, there is currently no commercially viable process that may remove unwanted impurities from aluminum scrap. The present disclosure is generally directed to purification of aluminum scrap that may recycled without sacrificing the purity levels of the purified aluminum product. Recycling of aluminum may also reduce energy consumptions as well as carbon dioxide equivalent (CO₂e) emissions as compared to traditional alumina smelting processes. In one embodiment, a closed-loop process may be employed. In another embodiment, an open-loop process is employed.

In one approach, a method comprises (a) adding a feedstock to an aluminum purification cell, wherein the feedstock includes aluminum scrap; (b) purifying the feedstock, thereby producing a purified aluminum stream and a raffinate stream; (c) separating components of the raffinate stream, thereby producing at least a first byproduct stream and a second byproduct stream; and (d) mixing at least a portion of the first byproduct stream with at least a portion of the purified aluminum from the purified aluminum stream to produce an aluminum alloy product. The produced aluminum alloy product may be of a predetermined composition and/or product form, suited for commercial use. Accordingly, aluminum scrap may be purified and one or more of its constituents may be re-used to produce commercially viable products.

As noted above, the method may include adding a feedstock to an aluminum purification cell. In some embodiments, the feedstock includes at least 50 wt. % Al (aluminum). In one embodiment, the feedstock includes at least 55 wt. % Al. In another embodiment, the feedstock includes at least 60 wt. % Al. In yet another embodiment, the feedstock includes at least 65 wt. % Al. In another embodiment, the feedstock includes at least 70 wt. % Al. In yet another embodiment, the feedstock includes at least 75 wt. % Al. In another embodiment, the feedstock includes at least 80 wt. % Al. In yet another embodiment, the feedstock includes at least 85 wt. % Al. In another embodiment, the feedstock includes at least 90 wt. % Al. In yet another embodiment, the feedstock includes at least 95 wt. % Al. In another embodiment, the feedstock includes at least 99 wt. % Al. In yet another embodiment, the feedstock includes at least 99.5 wt. % Al.

In one approach, the feedstock may include not greater than 99.5 wt. % Al. In one embodiment, the feedstock includes not greater than 99 wt. % Al. In another embodiment, the feedstock includes not greater than 98 wt. % Al. In yet another embodiment, the feedstock includes not greater than 97 wt. % Al. In another embodiment, the feedstock includes not greater than 96 wt. % Al. In yet another embodiment, the feedstock includes not greater than 95 wt. % Al. In another embodiment, the feedstock includes not greater than 94 wt. % Al. In yet another embodiment, the feedstock includes not greater than 93 wt. % Al. In another embodiment, the feedstock includes not greater than 92 wt. % Al. In yet another embodiment, the feedstock includes not greater than 91 wt. % Al. In another embodiment, the feedstock includes not greater than 90 wt. % Al. In yet another embodiment, the feedstock includes not greater than 85 wt. % Al. In another embodiment, the feedstock includes not greater than 80 wt. % Al. In yet another embodiment, the feedstock includes not greater than 75 wt. % Al. In another embodiment, the feedstock includes not greater than 70 wt. % Al. In yet another embodiment, the feedstock includes not greater than 65 wt. % Al. In another embodiment, the feedstock includes not greater than 60 wt. % Al. In yet another embodiment, the feedstock includes not greater than 55 wt. % Al.

In one embodiment, the feedstock includes 50-99 wt. % Al. In another embodiment, the feedstock includes 55-98 wt. % Al. In yet another embodiment, the feedstock includes 60-97 wt. % Al. In another embodiment, the feedstock includes 65-96 wt. % Al. In yet another embodiment, the feedstock includes 65-95 wt. % Al.

In one embodiment, the feedstock includes not greater than 5 wt. % alumina (Al₂O₃). In another embodiment, the feedstock includes not greater than 4 wt. % alumina (Al₂O₃. In yet another embodiment, the feedstock includes not greater than 3 wt. % alumina (Al₂O₃). In another embodiment, the feedstock includes not greater than 2 wt. % alumina (Al₂O₃). In yet another embodiment, the feedstock includes not greater than 1 wt. % alumina (Al₂O₃). In another embodiment, the feedstock includes not greater than 0.5 wt. % alumina (Al₂O₃). In yet another embodiment, the feedstock includes not greater than 0.25 wt. % alumina (Al₂O₃). In another embodiment, the feedstock includes not greater than 0.1 wt. % alumina (Al₂O₃).

As noted above, the feedstock may include aluminum scrap. The aluminum scrap may make up a part of, or all of, the feedstock. Accordingly, the aluminum of the feedstock may be based on the amount of aluminum in the aluminum scrap. In one embodiment, the aluminum scrap includes at least 5 wt. % Al of the feedstock (i.e., the aluminum content of the aluminum scrap makes up at least 5 wt. % of the total aluminum content of the feedstock). In one embodiment, the aluminum scrap includes at least 10 wt. % Al of the feedstock. In another embodiment, aluminum scrap includes at least 15 wt. % Al of the feedstock. In yet another embodiment, the aluminum scrap includes at least 20 wt. % Al of the feedstock. In another embodiment, the aluminum scrap includes at least 25 wt. % Al of the feedstock. In yet another embodiment, the aluminum scrap includes at least 30 wt. % Al of the feedstock. In another embodiment, the aluminum scrap includes, at least 35 wt. % Al of the feedstock. In yet another embodiment, the aluminum scrap includes at least 40 wt. % Al of the feedstock. In another embodiment, the aluminum scrap includes, at least 45 wt. % Al of the feedstock. In yet another embodiment, the aluminum scrap includes at least 50 wt. % Al of the feedstock. In another embodiment, the aluminum scrap includes at least 55 wt. % Al of the feedstock. In yet another embodiment, the aluminum scrap includes at least 60 wt. % Al of the feedstock. In another embodiment, the aluminum scrap includes at least 65 wt. % Al of the feedstock. In yet another embodiment, the aluminum scrap includes at least 70 wt. % Al of the feedstock. In another embodiment, the aluminum scrap includes at least 75 wt. % Al of the feedstock. In yet another embodiment, the aluminum scrap includes at least 80 wt. % Al of the feedstock. In another embodiment, the aluminum scrap includes at least 85 wt. % Al of the feedstock. In yet another embodiment, the aluminum scrap includes at least 90 wt. % Al of the feedstock. In another embodiment, the aluminum scrap includes at least 95 wt. % Al of the feedstock. In yet another embodiment, r the aluminum scrap includes at least 99 wt. % Al of the feedstock. In another embodiment, the aluminum scrap includes at least 99.5 wt. % Al of the feedstock. In yet another embodiment, the aluminum scrap includes at least 100 wt. % Al of the feedstock (i.e., the aluminum content of the aluminum scrap makes up all of the aluminum content of the feedstock).

As noted above, the method may include a purifying step (b), wherein the feedstock is purified (e.g., in an aluminum purification cell), thereby producing a purified aluminum stream and a raffinate stream. In one embodiment, the purifying step includes passing electrical current through at least one anode through an electrolytic bath and into at least one cathode. In one embodiment, the electrolyte has a density that is greater than that of the purified aluminum. In one embodiment, the purified aluminum gathers above the electrolyte. In one embodiment, the purified aluminum forms a purified aluminum layer. In one embodiment, the purified aluminum layer is disposed above an electrolyte of an aluminum purification cell.

The purified aluminum steam generally includes more aluminum than the feedstock. In one approach, the purified aluminum stream includes at least 95 wt. % Al and up to 99.999 wt. % Al. In one embodiment, the purified aluminum stream includes at least 95.5 wt. % Al. In another embodiment, the purified aluminum stream includes at least 96 wt. % Al. In yet another embodiment, the purified aluminum stream includes at least 96.5 wt. % Al. In another embodiment, the purified aluminum stream includes at least 97 wt. % Al. In yet another embodiment, the purified aluminum stream includes at least 97.5 wt. % Al. In another embodiment, the purified aluminum stream includes at least 98 wt. % Al. In yet another embodiment, the purified aluminum stream includes at least 98.5 wt. % Al. In another embodiment, the purified aluminum stream includes at least 99 wt. % Al. In yet another embodiment, the purified aluminum stream includes at least 99.5 wt. % Al. In another embodiment, the purified aluminum stream includes at least 99.75 wt. % Al. In yet another embodiment, the purified aluminum stream includes at least 99.8 wt. % Al. In another embodiment, the purified aluminum stream includes at least 99.85 wt. % Al. In yet another embodiment, the purified aluminum stream includes at least 99.9 wt. % Al. In another embodiment, the purified aluminum stream includes at least 99.95 wt. % Al.

As noted above, due the purification step, a raffinate stream may be produced. The raffinate stream generally includes less aluminum than the feedstock. In some embodiments, the raffinate stream includes not greater than 50 wt. % Al. In one embodiment, the raffinate stream includes not greater than 45 wt. % Al. In another embodiment, the raffinate stream includes not greater than 40 wt. % Al. In yet another embodiment, the raffinate stream includes not greater than 35 wt. % Al. In another embodiment, the raffinate stream includes not greater than 30 wt. % Al. In yet another embodiment, the raffinate stream includes not greater than 25 wt. % Al. In another embodiment, the raffinate stream includes not greater than 20 wt. % Al. In yet another embodiment, the raffinate stream includes not greater than 15 wt. % Al. In another embodiment, the raffinate stream includes not greater than 10 wt. % Al. In yet another embodiment, the raffinate stream includes not greater than 8 wt. % Al. In another embodiment, the raffinate stream includes not greater than 5 wt. % Al. In yet another embodiment, the raffinate stream includes not greater than 3 wt. % Al. In another embodiment, the raffinate stream includes not greater than 1 wt. % Al.

In one embodiment a raffinate stream includes at least 3 wt. % Si (silicon). In one embodiment, a raffinate stream includes at least 3 wt. % Fe (iron). In one embodiment, a raffinate stream include both at least 3 wt. % Si and at least 3 wt. % Fe. In one embodiment, a raffinate stream includes not greater than 99 wt. % Si. In another embodiment, a raffinate stream includes not greater than 95 wt. % Si. In one embodiment, a raffinate stream includes not greater than 99 wt. % Fe. In one embodiment, a raffinate stream includes not greater than 95 wt. % Fe.

As noted above, a method may include (c) separating components of the raffinate stream, thereby producing at least a first byproduct stream and a second byproduct stream. The method may further include (d) mixing at least a portion of the first byproduct stream with at least a portion of the purified aluminum from the purified aluminum stream to produce an aluminum alloy product. In some embodiments, the aluminum alloy product has a composition consistent with one of a 1xxx-8xxx aluminum alloy as defined by the Aluminum Association in the document International Alloy Designations and Chemical Composition Limits for Wrought Aluminum and Wrought Aluminum Alloys. In some embodiments, the present disclosure relates to a method, wherein the aluminum alloy product has a composition consistent with one of a 1xx-8xx aluminum alloys as defined by the Aluminum Association in the document entitled Designations and Chemical Composition Limits for Aluminum Alloys in the Form of Castings and Ingot.

In one embodiment, at least a portion of the first byproduct stream is used in combination with the purified aluminum steam to product an aluminum alloy product. In one embodiment, a majority of, or all of, the first byproduct stream is combined with the purified aluminum stream to produce an aluminum alloy product.

Additional byproduct streams may also be combined with the purified aluminum stream to produce the aluminum alloy product. In one embodiment, a portion of both the first byproduct stream and the second byproduct stream are combined with the purified aluminum stream to create the aluminum alloy product. In another embodiment, a portion of the first byproduct stream is combined with a portion of the purified aluminum stream to create a first aluminum alloy product. Relatedly, a portion of the second byproduct stream may be combined with a portion of the purified aluminum stream to create a second aluminum alloy product, the second aluminum alloy product having a different composition than the first aluminum alloy product. The same principles apply to any third and subsequent byproduct streams that may result. Accordingly, a variety of tailored aluminum alloy product compositions may be produced from aluminum scrap.

The byproduct stream(s) may include, for instance, one or more of silicon, iron, zinc, copper, and manganese. In one embodiment, the first byproduct stream and/or the second byproduct stream include at least one of: at least 12 wt. % Si, at least 3 wt. % Mn, at least 3 wt. % Fc, and combinations thereof. In one embodiment, the first byproduct stream and/or the second byproduct stream includes at least 5% of at least one of Si, Mn, Fe, Zn, Cu, and combinations thereof.

In addition to, or in lieu of, the use of the first byproduct stream, the method may include the use of additional component(s) to facilitate production of tailored (predetermined) aluminum alloy products. In one embodiment, a method includes mixing additional component(s) with the purified aluminum stream to facilitate production of aluminum alloy products. In one embodiment, the additional component(s) include at least one of Si, Fe, Cu, Ce, Cs, Mg, Mn, Cr, Ni, Zn, Ti, Co, Sn, Sr, Li, V, Zr, Sc, and combinations thereof. In one embodiment, the additional component(s) include one or more aluminum scrap alloys, i.e., scrap comprising aluminum alloys.

The first byproduct stream and/or a precursor stream may be used to facilitate production of the feedstock. In one embodiment, a method may include adding at least one of the first byproduct stream and/or the second byproduct stream to a precursor stream to produce the feedstock.

In one embodiment, a method includes adding a predetermined metal to a precursor stream. In one embodiment, the predetermined metal is at least one of Si, Fe, Cu, Ce, Cs, Mg, Mn, Cr, Ni, Zn, Ti, Co, Sn, Sr, Li, V, Zr, Sc, and combinations thereof. In one embodiment, the predetermined metal is at least one of Cu, Ce, Cs, Sn, Zn, and combinations thereof. In one embodiment, the predetermined metal is Cu.

The produced aluminum alloy products may be in any suitable form, such as in the form of ingot, billet, powders, wires, ribbons, and the like. Suitable wrought products (foil, sheet, plate, forgings, extrusions), shape cast products (e.g., die cast products), and additively manufactured products (e.g., 3D printed products) may be produced from the aluminum alloy products.

Although the embodiments disclosed herein relate generally to the purification of aluminum, it is anticipated that the embodiments of the present disclosure apply to purification of other elements and/or compounds as well. For example, the embodiments of the present disclosure may, alternatively or in addition to, relate to the purification of magnesium. In some embodiments, the systems, apparatuses, and/or methods of the present disclosure relate to a magnesium purification cell for producing purified magnesium from a magnesium feedstock. The foregoing embodiments are exemplary embodiments of the device, systems, or methods of the present disclosure and are therefore not to be considered limiting of its scope, for the device, systems, and methods of the present disclosure may admit to other equally effective embodiments.

### BRIEF DESCRIPTION OF THE DRAWINGS

FIG. 1 illustrates one embodiment of a method for purifying a feedstock.

FIG. 2 illustrates one embodiment of a process flow diagram in accordance with the present disclosure.

### DETAILED DESCRIPTION

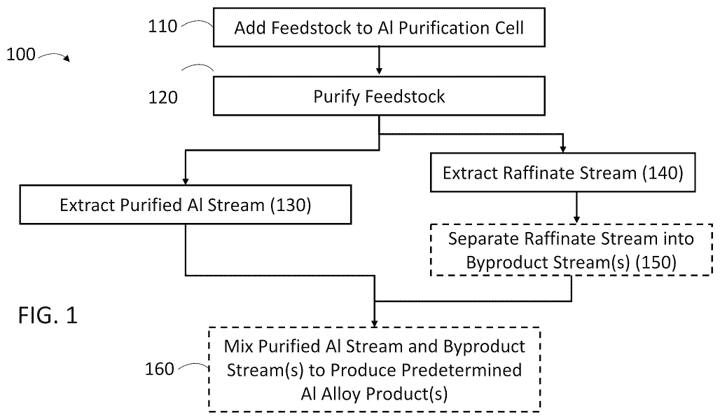

Referring now to FIG. 1, one non-limiting embodiment of a method 100 for purifying a feedstock is disclosed. Step 110 includes adding a feedstock to an aluminum purification cell. Step 120 includes purifying the feedstock via the aluminum purification cell. Step 120 includes producing a purified aluminum stream and a raffinate stream. Step 130 includes extracting the purified aluminum stream. Step 140 includes extracting the raffinate stream. Step 150 (optional) includes separating the raffinate stream into byproduct stream(s). Step 160 (optional) includes mixing the purified aluminum stream (e.g., the stream extracted in step 130) and at least one byproduct stream (e.g., a byproduct stream separated from the extracted raffinate stream in step 140) to produce a predetermined aluminum alloy product stream. As may be appreciated, FIG. 1 displays some of the steps in a dashed box, which indicates that these steps are optional.

As used herein, “aluminum feedstock” means a feedstock suited for production of purified aluminum in an aluminum purification cell. The aluminum feedstock may have any suitable aluminum content. Typically, an aluminum feedstock will have at least 50 wt. % aluminum, but lower amounts of aluminum may be used in the aluminum feedstock (e.g., at least 25 wt. % Al) in some embodiments. In some embodiments, an aluminum feedstock includes aluminum and at least one other metal (e.g., one or more of Si, Fe, Cu, Ce, Cs, Mg, Mn, Cr, Ni, Zn, Ti, Co, Sn, Sr, Li, V, Zr, Sc). In some embodiments, an aluminum feedstock includes a transition metal. In some embodiments, the aluminum feedstock is substantially free of alumina (Al₂O₃) as described herein.

As used herein, “purified aluminum” means material having at least 95 wt. % aluminum, as described herein.

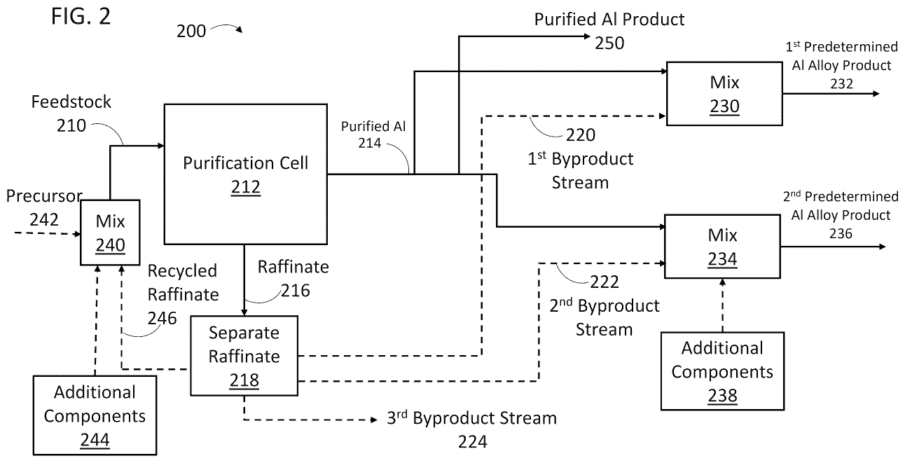

FIG. 2 illustrates is a representative flow diagram of the process 200 of the present disclosure, in accordance with some embodiments. In the illustrated embodiment, the process 200 includes adding a feedstock 210 to a purification cell 212. In some embodiments, the purification cell 212 is an aluminum purification cell. In some embodiments, the feedstock 210 includes aluminum scrap. The feedstock 210 may be purified by the purification cell 212. After purification, the purification cell 212 produces a purified aluminum stream 214 and a raffinate stream 216. The purified aluminum stream 214 may be collected as a purified aluminum product 250. The raffinate stream 216 may include impurities and/or other components not included in the purified aluminum stream. The raffinate stream 216 may be separated into one or more byproduct streams (220, 222, 224). Byproduct streams (e.g., a first byproduct stream 220) from the raffinate stream 216 may be mixed with the purified aluminum stream 214 to form a predetermined aluminum alloy product (e.g., a first predetermined aluminum alloy product 232).

In some embodiments, the feedstock 210 may be fed to the purification cell 212. In some embodiments, the feedstock 210 is fed to the purification cell without modification (e.g., the feedstock is not mixed together with other streams prior to introduction to the purification cell 212). The feedstock may be obtained from an outside source or may be obtained as a result of operation of the purification cell. In some embodiments, at least a portion of the feedstock 210 is the precursor 242. In other embodiments, at least a portion of the feedstock 210 is recycled raffinate 246.

The feedstock 210 may be fed to the purification cell in an amount required to produce a purified aluminum product. In some embodiments, adding the feedstock 210 to the purification cell 212 includes feeding the feedstock 210 continuously during operation of the purification cell 212. In some embodiments, adding the feedstock 210 to the purification cell 212 includes periodically or intermittently adding the feedstock 210 into the purification cell 212. In some embodiments, adding the feedstock 210 to the purification cell 212 includes metering feedstock 210 into the purification cell 212 at a first feed rate. The first feed rate may remain constant or may vary, including stopping and starting of the feeding of the feedstock 210 to the purification cell 212.

The process 200 may include adding a byproduct stream (e.g., first byproduct stream 220) to the feedstock 210 and prior to introduction to the purification cell 212. In some embodiments, the process 200 includes adding at least one of a first byproduct stream 220, a second byproduct stream 222, and/or a third byproduct stream 224 to the precursor 242 to produce the feedstock 210. As may be appreciated, while three byproduct streams are illustrated, any number of byproduct streams may be employed. Generally, at least two byproduct streams are utilized.

In some embodiments, the feedstock 210 may be prepared by the step of mixing 240 at least two streams together. In some embodiments, at least a portion of the feedstock 210 may be prepared by mixing at least two of the following streams: the precursor 242, additional components 244, recycled raffinate 246, a byproduct stream (e.g., first byproduct stream 220) or any combinations thereof. In other embodiments, the feedstock 210 is not mixed with other sources and is used as received.

In some embodiments, the additional components 244 include a metal. In some embodiments, the process 200 includes adding one or more predetermined metals to the precursor 242 to produce at least a portion of the feedstock 210. In some embodiments, the predetermined metal is at least one of Si, Fe, Cu, Ce, Cs, Mg, Mn, Cr, Ni, Zn, Ti, Co, Sn, Sr, Li, V, Zr, Sc, and combinations thereof. In some embodiments, the predetermined metal is at least one of Cu, Ce, Cs, Sn, Zn, and combinations thereof. In some embodiments, the predetermined metal at least comprises Cu. The precursor 242 may have the same components as the components of the feedstock 210, as described herein.

In some embodiments the feedstock 210 includes at least 50 wt. % Al. In one embodiment, the feedstock 210 includes at least 55 wt. % Al. In another embodiment, the feedstock 210 includes at least 60 wt. % Al. In yet another embodiment, the feedstock 210 includes at least 65 wt. % Al. In another embodiment, the feedstock 210 includes at least 70 wt. % Al. In yet another embodiment, the feedstock 210 includes at least 75 wt. % Al. In another embodiment, the feedstock 210 includes at least 80 wt. % Al. In yet another embodiment, the feedstock 210 includes at least 85 wt. % Al. In another embodiment, the feedstock 210 includes at least 90 wt. % Al. In yet another embodiment, the feedstock 210 includes at least 95 wt. % Al. In another embodiment, the feedstock 210 includes at least 99 wt. % Al. In yet another embodiment, the feedstock 210 includes at least 99.5 wt. % Al.

In one approach, the feedstock 210 may include not greater than 99.5 wt. % Al. In one embodiment, the feedstock 210 includes not greater than 99 wt. % Al. In another embodiment, the feedstock 210 includes not greater than 98 wt. % Al. In yet another embodiment, the feedstock 210 includes not greater than 97 wt. % Al. In another embodiment, the feedstock 210 includes not greater than 96 wt. % Al. In yet another embodiment, the feedstock 210 includes not greater than 95 wt. % Al. In another embodiment, the feedstock 210 includes not greater than 94 wt. % Al. In yet another embodiment, the feedstock 210 includes not greater than 93 wt. % Al. In another embodiment, the feedstock 210 includes not greater than 92 wt. % Al. In yet another embodiment, the feedstock 210 includes not greater than 91 wt. % Al. In another embodiment, the feedstock 210 includes not greater than 90 wt. % Al. In yet another embodiment, the feedstock 210 includes not greater than 85 wt. % Al. In another embodiment, the feedstock 210 includes not greater than 80 wt. % Al. In yet another embodiment, the feedstock 210 includes not greater than 75 wt. % Al. In another embodiment, the feedstock 210 includes not greater than 70 wt. % Al. In yet another embodiment, the feedstock 210 includes not greater than 65 wt. % Al. In another embodiment, the feedstock 210 includes not greater than 60 wt. % Al. In yet another embodiment, the feedstock 210 includes not greater than 55 wt. % Al.

In one embodiment, the feedstock 210 includes 50-99 wt. % Al. In another embodiment, the feedstock 210 includes 55-98 wt. % Al. In yet another embodiment, the feedstock 210 includes 60-97 wt. % Al. In another embodiment, the feedstock 210 includes 65-96 wt. % Al. In yet another embodiment, the feedstock 210 includes from 65-95 wt. % Al.

In one embodiment, the feedstock 210 includes not greater than 5 wt. % alumina (Al₂O₃). In another embodiment, the feedstock 210 includes not greater than 4 wt. % alumina (Al₂O₃). In yet another embodiment, the feedstock 210 includes not greater than 3 wt. % alumina (Al₂O₃). In another embodiment, the feedstock 210 includes not greater than 2 wt. % alumina (Al₂O₃). In yet another embodiment, the feedstock 210 includes not greater than 1 wt. % alumina (Al₂O₃). In another embodiment, the feedstock 210 includes not greater than 0.5 wt. % alumina (Al₂O₃). In yet another embodiment, the feedstock 210 includes not greater than 0.25 wt. % alumina (Al₂O₃). In another embodiment, the feedstock 210 includes not greater than 0.1 wt. % alumina (Al₂O₃).

The feedstock 210 may include impurities. In some embodiments, the impurities of the feedstock 210 may include Si, Fe, Cu, Ce, Cs, Mg, Mn, Cr, Ni, Zn, Ti, Co, Sn, Sr, Li, V, Zr, ScCr, Cu, Fe, Mg, Mn, Ni, Si, Ti, Zn, and combinations thereof. In some embodiments, the impurities of the feedstock 210 may include Cr, Cu, Fe, Mg, Mn, Ni, Si, Ti, Zn, and combinations thereof. In some embodiments, the feedstock 210 may have aluminum with up to 2 wt. % Mg along with other impurities. In some embodiments, the feedstock 210 includes impurities of from 0.5 wt. % to 50.0 wt. % of the feedstock 210. In some embodiments, the feedstock 210 includes impurities of from 5.0 wt. % to 50.0 wt. % of the feedstock 210. In some embodiments, the feedstock 210 includes impurities of from 10.0 wt. % to 50.0 wt. % of the feedstock 210. In some embodiments, the feedstock 210 includes impurities of from 15.0 wt. % to 50.0 wt. % of the feedstock 210. In some embodiments, the feedstock 210 includes impurities of from 20.0 wt. % to 50.0 wt. % of the feedstock 210. In some embodiments, the feedstock 210 includes impurities of from 25.0 wt. % to 50.0 wt. % of the feedstock 210. In some embodiments, the feedstock 210 includes impurities of from 30.0 wt. % to 50.0 wt. % of the feedstock 210. In some embodiments, the feedstock 210 includes impurities of from 35.0 wt. % to 50.0 wt. % of the feedstock 210. In some embodiments, the aluminum feedstock 210 includes impurities of from 40.0 wt. % to 50.0 wt. % of the feedstock 210. In some embodiments, the feedstock 210 includes impurities of from 45.0 wt. % to 50.0 wt. % of the feedstock 210. In some embodiments, the feedstock 210 includes impurities of from 0.5 wt. % to 45.0 wt. % of the feedstock 210. In some embodiments, the feedstock 210 includes impurities of from 0.5 wt. % to 40.0 wt. % of the feedstock 210. In some embodiments, the feedstock 210 includes impurities of from 0.5 wt. % to 35.0 wt. % of the feedstock 210. In some embodiments, the feedstock 210 includes impurities of from 0.5 wt. % to 30.0 wt. % of the feedstock 210. In some embodiments, the feedstock 210 includes impurities of from 0.5 wt. % to 25.0 wt. % of the feedstock 210. In some embodiments, the feedstock 210 includes impurities of from 0.5 wt. % to 20.0 wt. % of the feedstock 210. In some embodiments, the feedstock 210 includes impurities of from 0.5 wt. % to 15.0 wt. % of the feedstock 210. In some embodiments, the feedstock 210 includes impurities of from 0.5 wt. % to 10.0 wt. % of the feedstock 210. In some embodiments, the feedstock 210 includes impurities of from 0.5 wt. % to 5.0 wt. % of the feedstock 210.

In some embodiments, the feedstock 210 includes aluminum scrap. In some embodiments, the aluminum scrap is an aluminum alloy scrap, i.e., scrap comprising, consisting essentially of, or consisting of, one or more aluminum alloys. In some embodiments, the aluminum alloy scrap includes at least one of a 1xxx-8xxx aluminum alloy and combinations thereof. In one embodiment, the aluminum alloy scrap at least includes 1xxx-series aluminum alloy scrap. In another embodiment, the aluminum alloy scrap at least includes 2xxx-series aluminum alloy scrap. In yet another embodiment, the aluminum alloy scrap at least includes 3xxx-series aluminum alloy scrap. In another embodiment, the aluminum alloy scrap at least includes 4xxx-series aluminum alloy scrap. In yet another embodiment, the aluminum alloy scrap at least includes 5xxx-series aluminum alloy scrap. In another embodiment, the aluminum alloy scrap at least includes 6xxx-series aluminum alloy scrap. In yet another embodiment, the aluminum alloy scrap at least includes 7xxx-series aluminum alloy scrap. In another embodiment, the aluminum alloy scrap at least includes 8xxx-series aluminum alloy scrap.

In some embodiments, the aluminum alloy scrap includes at least one of a 1xx-8xx aluminum alloy and combinations thereof. In one embodiment, the aluminum alloy scrap at least includes 1xx-series aluminum alloy scrap. In another embodiment, the aluminum alloy scrap at least includes 2xx-series aluminum alloy scrap. In yet another embodiment, the aluminum alloy scrap at least includes 3xx-series aluminum alloy scrap. In another embodiment, the aluminum alloy scrap at least includes 4xx-series aluminum alloy scrap. In yet another embodiment, the aluminum alloy scrap at least includes 5xx-series aluminum alloy scrap. In yet another embodiment, the aluminum alloy scrap at least includes 7xx-series aluminum alloy scrap. In another embodiment, the aluminum alloy scrap at least includes 8xx-series aluminum alloy scrap.

In some embodiments, the present disclosure relates to a method, wherein the aluminum scrap includes at least 5 wt. % Al of the feedstock 210 (i.e., the aluminum content of the aluminum scrap makes up at least 5 wt. % of the total aluminum content of the feedstock 210). In one embodiment, the aluminum scrap includes at least 10 wt. % Al of the feedstock 210. In another embodiment, the aluminum scrap includes at least 15 wt. % Al of the feedstock 210. In yet another embodiment, the aluminum scrap includes at least 20 wt. % Al of the feedstock 210. In another embodiment, the aluminum scrap includes at least 25 wt. % Al of the feedstock 210. In yet another embodiment, the aluminum scrap includes at least 30 wt. % Al of the feedstock 210. In another embodiment, the aluminum scrap includes, at least 35 wt. % Al of the feedstock 210. In yet another embodiment, the aluminum scrap includes at least 40 wt. % Al of the feedstock 210. In another embodiment, the aluminum scrap includes, at least 45 wt. % Al of the feedstock 210. In yet another embodiment, the aluminum scrap includes at least 50 wt. % Al of the feedstock 210. In another embodiment, the aluminum scrap includes at least 55 wt. % Al of the feedstock 210. In yet another embodiment, the aluminum scrap includes at least 60 wt. % Al of the feedstock 210. In another embodiment, the aluminum scrap includes at least 65 wt. % Al of the feedstock 210. In yet another embodiment, the aluminum scrap includes at least 70 wt. % Al of the feedstock 210. In another embodiment, the aluminum scrap includes at least 75 wt. % Al of the feedstock 210. In yet another embodiment, the aluminum scrap includes at least 80 wt. % Al of the feedstock 210. In another embodiment, the aluminum scrap includes at least 85 wt. % Al of the feedstock 210. In yet another embodiment, the aluminum scrap includes at least 90 wt. % Al of the feedstock 210. In another embodiment, the aluminum scrap includes at least 95 wt. % Al of the feedstock 210. In yet another embodiment, the aluminum scrap includes at least 99 wt. % Al of the feedstock 210. In another embodiment, the aluminum scrap includes at least 99.5 wt. % Al of the feedstock 210. In yet another embodiment, the aluminum scrap includes at least 100 wt. % Al of the feedstock 210 (i.e., the aluminum content of the aluminum scrap makes up all of the aluminum content of the feedstock 210).

In some embodiments, additional components 244, such as additives (e.g., Cu, Ce, Cs, Sn, Zn, and combinations thereof), may be added to the feedstock 210 to increase or maintain its density, which may at least partially facilitate in keeping/maintaining the metal of the feedstock 210 on or near the bottom of the purification cell 212 at the molten metal pad.

In some embodiments, the feedstock 210 includes at least includes copper. In these embodiments, the feedstock may include at least 1 wt. % Cu and up to 50 wt. % Cu. In one embodiment, the feedstock including at least 5 wt. % Cu. In another embodiment, the feedstock 210 includes at least 10 wt. % Cu. In yet another embodiment, the feedstock 210 includes at least 15 wt. % Cu. In another embodiment, the feedstock 210 includes at least 20 wt. % Cu. In yet another embodiment, the feedstock 210 includes at least 25 wt. % Cu. In another embodiment, the feedstock 210 includes at least 30 wt. % Cu. In yet another embodiment, the feedstock 210 includes at least 35 wt. % Cu. In another embodiment, the feedstock 210 includes at least 40 wt. % Cu. In yet another embodiment, the feedstock 210 includes at least 45 wt. % Cu.

In some embodiments, the feedstock 210 includes at least includes cerium. In these embodiments, the feedstock may include at least 1 wt. % Ce and up to 50 wt. % Ce. In one embodiment, the feedstock including at least 5 wt. % Ce. In another embodiment, the feedstock 210 includes at least 10 wt. % Ce. In yet another embodiment, the feedstock 210 includes at least 15 wt. % Ce. In another embodiment, the feedstock 210 includes at least 20 wt. % Ce. In yet another embodiment, the feedstock 210 includes at least 25 wt. % Ce. In another embodiment, the feedstock 210 includes at least 30 wt. % Ce. In yet another embodiment, the feedstock 210 includes at least 35 wt. % Ce. In another embodiment, the feedstock 210 includes at least 40 wt. % Ce. In yet another embodiment, the feedstock 210 includes at least 45 wt. % Ce.

In some embodiments, the feedstock 210 includes at least includes cesium. In these embodiments, the feedstock may include at least 1 wt. % Cs and up to 50 wt. % Cs. In one embodiment, the feedstock including at least 5 wt. % Cs. In another embodiment, the feedstock 210 includes at least 10 wt. % Cs. In yet another embodiment, the feedstock 210 includes at least 15 wt. % Cs. In another embodiment, the feedstock 210 includes at least 20 wt. % Cs. In yet another embodiment, the feedstock 210 includes at least 25 wt. % Cs. In another embodiment, the feedstock 210 includes at least 30 wt. % Cs. In yet another embodiment, the feedstock 210 includes at least 35 wt. % Cs. In another embodiment, the feedstock 210 includes at least 40 wt. % Cs. In yet another embodiment, the feedstock 210 includes at least 45 wt. % Cs.

In some embodiments, the feedstock 210 includes at least includes tin. In these embodiments, the feedstock may include at least 1 wt. % Sn and up to 50 wt. % Sn. In one embodiment, the feedstock including at least 5 wt. % Sn. In another embodiment, the feedstock 210 includes at least 10 wt. % Sn. In yet another embodiment, the feedstock 210 includes at least 15 wt. % Sn. In another embodiment, the feedstock 210 includes at least 20 wt. % Sn. In yet another embodiment, the feedstock 210 includes at least 25 wt. % Sn. In another embodiment, the feedstock 210 includes at least 30 wt. % Sn. In yet another embodiment, the feedstock 210 includes at least 35 wt. % Sn. In another embodiment, the feedstock 210 includes at least 40 wt. % Sn. In yet another embodiment, the feedstock 210 includes at least 45 wt. % Sn.

In some embodiments, the feedstock 210 includes at least includes copper. In these embodiments, the feedstock may include at least 1 wt. % Zn and up to 50 wt. % Zn. In one embodiment, the feedstock including at least 5 wt. % Zn. In another embodiment, the feedstock 210 includes at least 10 wt. % Zn. In yet another embodiment, the feedstock 210 includes at least 15 wt. % Zn. In another embodiment, the feedstock 210 includes at least 20 wt. % Zn. In yet another embodiment, the feedstock 210 includes at least 25 wt. % Zn. In another embodiment, the feedstock 210 includes at least 30 wt. % Zn. In yet another embodiment, the feedstock 210 includes at least 35 wt. % Zn. In another embodiment, the feedstock 210 includes at least 40 wt. % Zn. In yet another embodiment, the feedstock 210 includes at least 45 wt. % Zn.

In some embodiments, the purified aluminum stream 214 is not mixed with any further streams. The purified aluminum stream 214 may be the same as the purified aluminum product 250. In some embodiments, additional components (e.g., additional components 238 or additional components 244) may be mixed with the purified aluminum stream 214 to produce the purified aluminum product 250 and/or an aluminum alloy product 236.

In some embodiments, the purified aluminum product 250 includes at least 95 wt. % Al and up to 99.999 wt. % Al. In some embodiments, the purified aluminum product 250 includes an aluminum purity of at least 99.5 wt. % up to 99.999 wt. % aluminum. In some embodiments, the purified aluminum product 250 includes an aluminum purity of at least 99.9 wt. % up to 99.999 wt. % aluminum. In some embodiments, the purified aluminum product 250 includes an aluminum purity of at least 99.98 wt. % up to 99.999 wt. % aluminum. In one embodiment, the purified aluminum product includes at least 95.5 wt. % Al. In another embodiment, the purified aluminum product includes at least 96 wt. % Al. In yet another embodiment, the purified aluminum product includes at least 96.5 wt. % Al. In another embodiment, the purified aluminum product includes at least 97 wt. % Al. In yet another embodiment, the purified aluminum product includes at least 97.5 wt. % Al. In another embodiment, the purified aluminum product includes at least 98 wt. % Al. In yet another embodiment, the purified aluminum product includes at least 98.5 wt. % Al. In another embodiment, the purified aluminum product includes at least 99 wt. % Al. In yet another embodiment, the purified aluminum product includes at least 99.5 wt. % Al. In another embodiment, the purified aluminum product includes at least 99.75 wt. % Al. In yet another embodiment, the purified aluminum product includes at least 99.8 wt. % Al. In another embodiment, the purified aluminum product includes at least 99.85 wt. % Al. In yet another embodiment, the purified aluminum product includes at least 99.9 wt. % Al. In another embodiment, the purified aluminum product includes at least 99.95 wt. % Al.

In some embodiments, the purified aluminum product 250 may be produced via the purification cell 212 at an energy efficiency of 1 to 15 kWh/kg of purified aluminum. In some embodiments, the purified aluminum product 250 may be produced via the purification cell 212 at an energy efficiency of 1 to 10 kWh/kg of purified aluminum. In some embodiments, the purified aluminum product 250 may be produced via the purification cell 212 at an energy efficiency of 1 to 8 kWh/kg of purified aluminum. In some embodiments, the purified aluminum product 250 may be produced via the purification cell 212 at an energy efficiency of 1 to 6 kWh/kg of purified aluminum. In some embodiments, the purified aluminum product 250 may be produced via the purification cell 212 at an energy efficiency of 1 to 4 kWh/kg of purified aluminum. In some embodiments, the purified aluminum product 250 may be produced via the purification cell 212 at an energy efficiency of 5 to 15 kWh/kg of purified aluminum. In some embodiments, the purified aluminum product 250 may be produced via the purification cell 212 at an energy efficiency of 10 to 15 kWh/kg of purified aluminum. In some embodiments, the purified aluminum product 250 may be produced via the purification cell 212 at an energy efficiency of 12 to 15 kWh/kg of purified aluminum.

In some embodiments, purifying the feedstock 210 and producing the purified aluminum stream 214 and the raffinate stream 216 includes passing electrical current through at least one anode, through an electrolyte (e.g., an electrolytic bath) and into at least one cathode. In some embodiments, the passing electrical current step includes passing direct current (DC) from the anode to the cathode through the electrolyte. In some embodiments, the anode and the cathode may be partially disposed in the electrolyte and the anode may be partially disposed in a molten metal pad. Directing aluminum metal of a molten metal pad of the purification cell 212 towards the electrolyte may include flowing aluminum metal towards the electrolyte and supplying an electric current to the anode.

In some embodiments, the purification cell 212 includes a molten metal pad, electrolyte, and purified aluminum. In one embodiment, the electrolyte separates the molten metal pad from the purified aluminum. In one embodiment, the purified aluminum defines a top liquid layer of the purification cell 21, the electrolyte defines a middle liquid layer of the purification cell 212, and the molten metal pad defines a bottom liquid layer of the purification cell 212. The purified aluminum of the purification cell 212 may have a density less than the electrolyte of the purification cell 212. The electrolyte may have a density less than the molten metal pad of the purification cell 212. The electrolyte may separate the top layer of purified aluminum from the molten metal pad. In this regard, the composition of the electrolyte may be selected such that the electrolyte has a lower density than the molten metal pad and higher density than the purified aluminum. In some embodiments, the electrolyte includes one or more molten salts. In some embodiments, the electrolyte includes at least one of fluorides and/or chlorides. In some embodiments, the electrolyte contains at least one of fluorides and/or chlorides of Na, K, Al, Ba, Ca, Ce, La, Cs, Rb, or combinations thereof, among others. In some embodiments, the molten metal pad includes at least one alloy including one or more of Al, Si, Cu, Fc, Sb, Gd, Cd, Sn, Pb and impurities.

In some embodiments, the process 200 may include removing at least some of the purified aluminum from the purification cell 212 to form the purified aluminum stream 214. In some embodiments, the purified aluminum may be removed essentially continuously during operation of the purification cell 212 via the purified aluminum stream 214. In some embodiments, removing the purified aluminum from the purification cell 212 includes periodically removing the purified aluminum from the purification cell 212 via the purified aluminum stream 214. In some embodiments, removing the purified aluminum from the purification cell 212 via the purified aluminum stream 214 includes removing the purified aluminum from the purification cell 212 at a first removal rate. The first removal rate may remain constant or may vary, including stopping and starting of the removing of the purified aluminum from the purification cell 212. In some embodiments, a first removal rate may be controlled, for example, based at least in part on a second removal rate. In some embodiments, the purified aluminum may be removed periodically during operation of the purification cell 212 via the purified aluminum stream 214. In some embodiments, the removing step is completed with equipment configured to remove the purified aluminum product 250 without contaminating the product (e.g., alumina, graphite).

In some embodiments, the purified aluminum stream 214 includes at least 95 wt. % aluminum, such as any of the amounts of aluminum described herein.

As noted previously, the raffinate steam may include elements such as silicon and iron. In some embodiments, the raffinate stream 216 includes at least 0.5 wt. % Si. In one embodiment, the raffinate stream includes at least 1 wt. % Si. In another embodiment, the raffinate stream includes at least 2 wt. % Si. In yet another embodiment, the raffinate stream includes at least 3 wt. % Si. In another embodiment, the raffinate stream includes at least 5 wt. % Si. In yet another embodiment, the raffinate stream includes at least 7 wt. % Si. In another embodiment, the raffinate stream includes at least 10 wt. % Si. In yet another embodiment, the raffinate stream includes at least 15 wt. % Si. In another embodiment, the raffinate stream includes at least 20 wt. % Si. In yet another embodiment, the raffinate stream includes at least 25 wt. % Si. In another embodiment, the raffinate stream includes at least 30 wt. % Si. In yet another embodiment, the raffinate stream includes at least 35 wt. % Si. In another embodiment, the raffinate stream includes at least 40 wt. % Si. In yet another embodiment, the raffinate stream includes at least 45 wt. % Si. In another embodiment, the raffinate stream includes at least 50 wt. % Si. In yet another embodiment, the raffinate stream includes at least 55 wt. % Si. In another embodiment, the raffinate stream includes at least 60 wt. % Si. In yet another embodiment, the raffinate stream includes at least 65 wt. % Si. In another embodiment, the raffinate stream includes at least 70 wt. % Si. In yet another embodiment, the raffinate stream includes at least 75 wt. % Si. In another embodiment, the raffinate stream includes at least 80 wt. % Si. In yet another embodiment, the raffinate stream includes at least 85 wt. % Si. In another embodiment, the raffinate stream includes at least 90 wt. % Si. In yet another embodiment, the raffinate stream includes at least 95 wt. % Si.

In some embodiments, the raffinate stream 216 includes at least 0.5 wt. % of Fc. In one embodiment, the raffinate stream includes at least 1 wt. % Fe. In another embodiment, the raffinate stream includes at least 2 wt. % Fc. In yet another embodiment, the raffinate stream includes at least 3 wt. % Fe. In another embodiment, the raffinate stream includes at least 5 wt. % Fe. In yet another embodiment, the raffinate stream includes at least 7 wt. % Fc. In another embodiment, the raffinate stream includes at least 10 wt. % Fe. In yet another embodiment, the raffinate stream includes at least 15 wt. % Fe. In another embodiment, the raffinate stream includes at least 20 wt. % Fe. In yet another embodiment, the raffinate stream includes at least 25 wt. % Fe. In another embodiment, the raffinate stream includes at least 30 wt. % Fe. In yet another embodiment, the raffinate stream includes at least 35 wt. % Fe. In another embodiment, the raffinate stream includes at least 40 wt. % Fe. In yet another embodiment, the raffinate stream includes at least 45 wt. % Fe. In another embodiment, the raffinate stream includes at least 50 wt. % Fe. In yet another embodiment, the raffinate stream includes at least 55 wt. % Fe. In another embodiment, the raffinate stream includes at least 60 wt. % Fe. In yet another embodiment, the raffinate stream includes at least 65 wt. % Fe. In another embodiment, the raffinate stream includes at least 70 wt. % Fe. In yet another embodiment, the raffinate stream includes at least 75 wt. % Fe. In another embodiment, the raffinate stream includes at least 80 wt. % Fe. In yet another embodiment, the raffinate stream includes at least 85 wt. % Fe. In another embodiment, the raffinate stream includes at least 90 wt. % Fe. In yet another embodiment, the raffinate stream includes at least 95 wt. % Fc.

In some embodiments, the raffinate stream includes both silicon and iron and the raffinate stream includes at least 1 wt. % of the silicon plus iron (i.e., ≥1 wt. % Si+Fe). In another embodiment, the raffinate stream includes at least 2 wt. % (Si+Fc). In yet another embodiment, the raffinate stream includes at least 3 wt. % (Si+Fc). In another embodiment, the raffinate stream includes at least 5 wt. % (Si+Fe). In yet another embodiment, the raffinate stream includes at least 7 wt. % (Si+Fe). In another embodiment, the raffinate stream includes at least 10 wt. % (Si+Fc). In yet another embodiment, the raffinate stream includes at least 15 wt. % (Si+Fe). In another embodiment, the raffinate stream includes at least 20 wt. % (Si+Fe). In yet another embodiment, the raffinate stream includes at least 25 wt. % (Si+Fc). In another embodiment, the raffinate stream includes at least 30 wt. % (Si+Fe). In yet another embodiment, the raffinate stream includes at least 35 wt. % (Si+Fc). In another embodiment, the raffinate stream includes at least 40 wt. % (Si+Fc). In yet another embodiment, the raffinate stream includes at least 45 wt. % (Si+Fc). In another embodiment, the raffinate stream includes at least 50 wt. % (Si+Fe). In yet another embodiment, the raffinate stream includes at least 55 wt. % (Si+Fe). In another embodiment, the raffinate stream includes at least 60 wt. % (Si+Fe). In yet another embodiment, the raffinate stream includes at least 65 wt. % (Si+Fe). In another embodiment, the raffinate stream includes at least 70 wt. % (Si+Fe). In yet another embodiment, the raffinate stream includes at least 75 wt. % (Si+Fe). In another embodiment, the raffinate stream includes at least 80 wt. % (Si+Fe). In yet another embodiment, the raffinate stream includes at least 85 wt. % (Si+Fe). In another embodiment, the raffinate stream includes at least 90 wt. % (Si+Fe). In yet another embodiment, the raffinate stream includes at least 95 wt. % (Si+Fc).

In some embodiments, the raffinate stream 216 includes not greater than 95 wt. % Al (aluminum). In one embodiment, the raffinate stream 216 includes not greater than 90 wt. % Al. In another embodiment, the raffinate stream 216 includes not greater than 85 wt. % Al. In yet another embodiment, the raffinate stream 216 includes not greater than 80 wt. % Al. In another embodiment, the raffinate stream 216 includes not greater than 75 wt. % Al. In yet another embodiment, the raffinate stream 216 includes not greater than 70 wt. % Al. In another embodiment, the raffinate stream 216 includes not greater than 65 wt. % Al. In yet another embodiment, the raffinate stream 216 includes not greater than 60 wt. % Al. In another embodiment, the raffinate stream 216 includes not greater than 55 wt. % Al. In yet another embodiment, the raffinate stream 216 includes not greater than 50 wt. % Al. In another embodiment, the raffinate stream 216 includes not greater than 45 wt. % Al. In yet another embodiment, the raffinate stream 216 includes not greater than 40 wt. % Al. In another embodiment, the raffinate stream 216 includes not greater than 35 wt. % Al. In yet another embodiment, the raffinate stream 216 includes not greater than 30 wt. % Al. In another embodiment, the raffinate stream 216 includes not greater than 25 wt. % Al. In yet another embodiment, the raffinate stream 216 includes not greater than 20 wt. % Al. In another embodiment, the raffinate stream 216 includes not greater than 15 wt. % Al. In yet another embodiment, the raffinate stream 216 includes not greater than 10 wt. % Al. In another embodiment, the raffinate stream 216 includes not greater than 5 wt. % Al.

The process 200 may include the step of separating 218 the raffinate stream 216 into a recycled raffinate 246, a byproduct stream(s), or a combination thereof. In some embodiments, the raffinate stream 216 is separated into only byproduct streams(s) (e.g., first byproduct stream 220, second byproduct stream 222, or third byproduct stream 224). In some embodiments, the raffinate stream 216 is not further separated and the raffinate stream 216 is the recycled raffinate 246. In some embodiments, the recycled raffinate 246 does not include the same components as the byproduct stream(s). In some embodiments, the recycled raffinate 246 includes the same components as at least one of the byproduct streams. In some embodiments, the recycled raffinate 246 is the same as all of the byproduct stream(s).

Depending on the application, the number of byproduct streams leaving the step of separating 218 may vary. As shown in FIG. 2, the raffinate stream 216 may be separated into at least one byproduct stream, e.g., first byproduct stream 220, a second byproduct stream 222, and a third byproduct stream 224. In some embodiments, the raffinate stream 216 may be separated into two or more byproduct streams, e.g., only two byproduct streams, or three or more byproduct streams, or four or more byproduct streams, or five or more byproduct streams, or six or more byproduct streams, or seven or more byproduct streams, or eight or more byproduct streams, or nine or more byproduct streams, or ten or more byproduct streams.

In some embodiments, the byproduct streams may all be the same or may all be compositionally different from one another. In some embodiments, some of the byproduct streams may be compositionally the same, and some of the byproduct streams may differ from one another. In some embodiments, two or more of the streams may be compositionally the same (e.g., first byproduct stream 220 and second byproduct stream 222) and may be different from other stream(s) (e.g., third byproduct stream 224). The first byproduct stream 220, the second byproduct stream 222, and the third byproduct stream 224 may be compositionally the same or all different from one another.

The byproduct stream(s) of the present disclosure (e.g., in the illustrated embodiment, the first byproduct stream 220, the second byproduct stream 222, and/or the third byproduct stream 224) may include at least one of silicon, manganese, iron, zinc, copper, and combinations thereof.

In some embodiments, at least one of the byproduct stream(s) includes at least 1 wt. % Si (silicon). In one embodiment, at least one of the byproduct stream(s) includes at least 3 wt. % Si. In another embodiment, at least one of the byproduct stream(s) includes at least 5 wt. % Si. In yet another embodiment, at least one of the byproduct stream(s) includes at least 7 wt. % Si. In another embodiment, at least one of the byproduct stream(s) includes at least 10 wt. % Si. In yet another embodiment, at least one of the byproduct stream(s) includes at least 12 wt. % Si. In another embodiment, at least one of the byproduct stream(s) includes at least 15 wt. % Si. In yet another embodiment, at least one of the byproduct stream(s) includes at least 20 wt. % Si. In another embodiment, at least one of the byproduct stream(s) includes at least 25 wt. % Si. In yet another embodiment, at least one of the byproduct stream(s) includes at least 30 wt. % Si. In another embodiment, at least one of the byproduct stream(s) includes at least 35 wt. % Si. In yet another embodiment, at least one of the byproduct stream(s) includes at least 40 wt. % Si. In another embodiment, at least one of the byproduct stream(s) includes at least 45 wt. % Si. In yet another embodiment, at least one of the byproduct stream(s) includes at least 50 wt. % Si. In another embodiment, at least one of the byproduct stream(s) includes at least 55 wt. % Si. In yet another embodiment, at least one of the byproduct stream(s) includes at least 60 wt. % Si. In another embodiment, at least one of the byproduct stream(s) includes at least 65 wt. % Si. In yet another embodiment, at least one of the byproduct stream(s) includes at least 70 wt. % Si. In another embodiment, at least one of the byproduct stream(s) includes at least 75 wt. % Si. In yet another embodiment, at least one of the byproduct stream(s) includes at least 80 wt. % Si. In another embodiment, at least one of the byproduct stream(s) includes at least 85 wt. % Si. In yet another embodiment, at least one of the byproduct stream(s) includes at least 90 wt. % Si. In another embodiment, at least one of the byproduct stream(s) includes at least 95 wt. % Si.

In some embodiments, at least one of the byproduct stream(s) includes at least 1 wt. % Mn (manganese). In one embodiment, at least one of the byproduct stream(s) includes at least 3 wt. % Mn. In another embodiment, at least one of the byproduct stream(s) includes at least 5 wt. % Mn. In yet another embodiment, at least one of the byproduct stream(s) includes at least 7 wt. % Mn. In another embodiment, at least one of the byproduct stream(s) includes at least 10 wt. % Mn. In yet another embodiment, at least one of the byproduct stream(s) includes at least 12 wt. % Mn. In another embodiment, at least one of the byproduct stream(s) includes at least 15 wt. % Mn. In yet another embodiment, at least one of the byproduct stream(s) includes at least 20 wt. % Mn. In another embodiment, at least one of the byproduct stream(s) includes at least 25 wt. % Mn. In yet another embodiment, at least one of the byproduct stream(s) includes at least 30 wt. % Mn. In another embodiment, at least one of the byproduct stream(s) includes at least 35 wt. % Mn. In yet another embodiment, at least one of the byproduct stream(s) includes at least 40 wt. % Mn. In another embodiment, at least one of the byproduct stream(s) includes at least 45 wt. % Mn. In yet another embodiment, at least one of the byproduct stream(s) includes at least 50 wt. % Mn. In another embodiment, at least one of the byproduct stream(s) includes at least 55 wt. % Mn. In yet another embodiment, at least one of the byproduct stream(s) includes at least 60 wt. % Mn. In another embodiment, at least one of the byproduct stream(s) includes at least 65 wt. % Mn. In yet another embodiment, at least one of the byproduct stream(s) includes at least 70 wt. % Mn. In another embodiment, at least one of the byproduct stream(s) includes at least 75 wt. % Mn. In yet another embodiment, at least one of the byproduct stream(s) includes at least 80 wt. % Mn. In another embodiment, at least one of the byproduct stream(s) includes at least 85 wt. % Mn. In yet another embodiment, at least one of the byproduct stream(s) includes at least 90 wt. % Mn. In another embodiment, at least one of the byproduct stream(s) includes at least 95 wt. % Mn.

In some embodiments, at least one of the byproduct stream(s) includes at least 1 wt. % Fe (iron). In one embodiment, at least one of the byproduct stream(s) includes at least 3 wt. % Fc. In another embodiment, at least one of the byproduct stream(s) includes at least 5 wt. % Fe. In yet another embodiment, at least one of the byproduct stream(s) includes at least 7 wt. % Fe. In another embodiment, at least one of the byproduct stream(s) includes at least 10 wt. % Fe. In yet another embodiment, at least one of the byproduct stream(s) includes at least 12 wt. % Fe. In another embodiment, at least one of the byproduct stream(s) includes at least 15 wt. % Fe. In yet another embodiment, at least one of the byproduct stream(s) includes at least 20 wt. % Fc. In another embodiment, at least one of the byproduct stream(s) includes at least 25 wt. % Fe. In yet another embodiment, at least one of the byproduct stream(s) includes at least 30 wt. % Fc. In another embodiment, at least one of the byproduct stream(s) includes at least 35 wt. % Fe. In yet another embodiment, at least one of the byproduct stream(s) includes at least 40 wt. % Fe. In another embodiment, at least one of the byproduct stream(s) includes at least 45 wt. % Fe. In yet another embodiment, at least one of the byproduct stream(s) includes at least 50 wt. % Fe. In another embodiment, at least one of the byproduct stream(s) includes at least 55 wt. % Fe. In yet another embodiment, at least one of the byproduct stream(s) includes at least 60 wt. % Fc. In another embodiment, at least one of the byproduct stream(s) includes at least 65 wt. % Fe. In yet another embodiment, at least one of the byproduct stream(s) includes at least 70 wt. % Fe. In another embodiment, at least one of the byproduct stream(s) includes at least 75 wt. % Fe. In yet another embodiment, at least one of the byproduct stream(s) includes at least 80 wt. % Fe. In another embodiment, at least one of the byproduct stream(s) includes at least 85 wt. % Fe. In yet another embodiment, at least one of the byproduct stream(s) includes at least 90 wt. % Fc. In another embodiment, at least one of the byproduct stream(s) includes at least 95 wt. % Fc.

In some embodiments, at least one of the byproduct stream(s) includes at least 1 wt. % Zn (zinc). In one embodiment, at least one of the byproduct stream(s) includes at least 3 wt. % Zn. In another embodiment, at least one of the byproduct stream(s) includes at least 5 wt. % Zn. In yet another embodiment, at least one of the byproduct stream(s) includes at least 7 wt. % Zn. In another embodiment, at least one of the byproduct stream(s) includes at least 10 wt. % Zn. In yet another embodiment, at least one of the byproduct stream(s) includes at least 12 wt. % Zn. In another embodiment, at least one of the byproduct stream(s) includes at least 15 wt. % Zn. In yet another embodiment, at least one of the byproduct stream(s) includes at least 20 wt. % Zn. In another embodiment, at least one of the byproduct stream(s) includes at least 25 wt. % Zn. In yet another embodiment, at least one of the byproduct stream(s) includes at least 30 wt. % Zn. In another embodiment, at least one of the byproduct stream(s) includes at least 35 wt. % Zn. In yet another embodiment, at least one of the byproduct stream(s) includes at least 40 wt. % Zn. In another embodiment, at least one of the byproduct stream(s) includes at least 45 wt. % Zn. In yet another embodiment, at least one of the byproduct stream(s) includes at least 50 wt. % Zn. In another embodiment, at least one of the byproduct stream(s) includes at least 55 wt. % Zn. In yet another embodiment, at least one of the byproduct stream(s) includes at least 60 wt. % Zn. In another embodiment, at least one of the byproduct stream(s) includes at least 65 wt. % Zn. In yet another embodiment, at least one of the byproduct stream(s) includes at least 70 wt. % Zn. In another embodiment, at least one of the byproduct stream(s) includes at least 75 wt. % Zn. In yet another embodiment, at least one of the byproduct stream(s) includes at least 80 wt. % Zn. In another embodiment, at least one of the byproduct stream(s) includes at least 85 wt. % Zn. In yet another embodiment, at least one of the byproduct stream(s) includes at least 90 wt. % Zn. In another embodiment, at least one of the byproduct stream(s) includes at least 95 wt. % Zn.

In some embodiments, at least one of the byproduct stream(s) includes at least 1 wt. % Cu (copper). In one embodiment, at least one of the byproduct stream(s) includes at least 3 wt. % Cu. In another embodiment, at least one of the byproduct stream(s) includes at least 5 wt. % Cu. In yet another embodiment, at least one of the byproduct stream(s) includes at least 7 wt. % Cu. In another embodiment, at least one of the byproduct stream(s) includes at least 10 wt. % Cu. In yet another embodiment, at least one of the byproduct stream(s) includes at least 12 wt. % Cu. In another embodiment, at least one of the byproduct stream(s) includes at least 15 wt. % Cu. In yet another embodiment, at least one of the byproduct stream(s) includes at least 20 wt. % Cu. In another embodiment, at least one of the byproduct stream(s) includes at least 25 wt. % Cu. In yet another embodiment, at least one of the byproduct stream(s) includes at least 30 wt. % Cu. In another embodiment, at least one of the byproduct stream(s) includes at least 35 wt. % Cu. In yet another embodiment, at least one of the byproduct stream(s) includes at least 40 wt. % Cu. In another embodiment, at least one of the byproduct stream(s) includes at least 45 wt. % Cu. In yet another embodiment, at least one of the byproduct stream(s) includes at least 50 wt. % Cu. In another embodiment, at least one of the byproduct stream(s) includes at least 55 wt. % Cu. In yet another embodiment, at least one of the byproduct stream(s) includes at least 60 wt. % Cu. In another embodiment, at least one of the byproduct stream(s) includes at least 65 wt. % Cu. In yet another embodiment, at least one of the byproduct stream(s) includes at least 70 wt. % Cu. In another embodiment, at least one of the byproduct stream(s) includes at least 75 wt. % Cu. In yet another embodiment, at least one of the byproduct stream(s) includes at least 80 wt. % Cu. In another embodiment, at least one of the byproduct stream(s) includes at least 85 wt. % Cu. In yet another embodiment, at least one of the byproduct stream(s) includes at least 90 wt. % Cu. In another embodiment, at least one of the byproduct stream(s) includes at least 95 wt. % Cu.

In some embodiments, the first byproduct stream 220, the second byproduct stream 222, the third byproduct stream 224, or any combinations thereof, may include at least one of: at least 12 wt. % Si, at least 3 wt. % Mn, at least 3 wt. % Fc, and combinations thereof, such as any of the amounts described above. In some embodiments, the first byproduct stream 220, the second byproduct stream 222, and/or the third byproduct stream 224 may include at least 5% of at least one of Si, Mn, Fc, Zn, Cu, and combinations thereof, such as any of the amounts described above.

As noted previously, additional components 238 may be used in the process 200. In one embodiment, the additional components 238 may include at least one of Si, Fe, Cu, Ce, Cs, Mg, Mn, Cr, Ni, Zn, Ti, Co, Sn, Sr, Li, V, Zr, Sc, and combinations thereof. In one embodiment, the additional components may include aluminum scrap alloys, as described herein. Additional components 238 may be added to any of the streams described herein (e.g., purified aluminum stream 214, purified aluminum product 250, first byproduct stream 220, second byproduct stream 222, and/or third byproduct stream 224). The additional components 238 may be selected in quantities appropriate to achieve predetermined aluminum alloy product compositions.

In some embodiments, one or more streams of the present disclosure are mixed with the additional components 238 and/or additional components 244. In some embodiments, additional components 238 and/or additional components 244 are not added to the streams. The step of mixing (e.g., the step of mixing 230 and/or the step of mixing 234) the byproduct stream (e.g., first byproduct stream 220 and second byproduct stream 222) with the purified aluminum stream 214 may include adding additional components 238. In the illustrated embodiment of FIG. 2, the step of mixing 234 includes adding additional components 238. In some embodiments, additional components 238 may be added to third byproduct stream 224 and/or purified aluminum product 250.

The process 200 may include the step of mixing 230 at least a portion of the first byproduct stream 220 with at least a portion of the purified aluminum from the purified aluminum stream 214 to produce an aluminum alloy product, i.e., a first predetermined aluminum alloy product 232.

The process 200 may include the step of mixing 234 at least a portion of the second byproduct stream 222 with at least a portion of the purified aluminum from the purified aluminum stream 214 to produce an aluminum alloy product, i.e., a second predetermined aluminum alloy product 236. The second predetermined aluminum alloy product may have a different composition than the first predetermined aluminum alloy product.

The first predetermined aluminum alloy product 232 and/or the second predetermined aluminum alloy product 236 may have a composition consistent with any of a 1xxx-8xxx aluminum alloy product, such as any of the 1xxx-8xxx aluminum alloys described in the Aluminum Association document International Alloy Designations and Chemical Composition Limits for Wrought Aluminum and Wrought Aluminum Alloys. The first predetermined aluminum alloy product 232 and/or the second predetermined aluminum alloy product 236 may have a composition consistent with any of a 1xx-8xx aluminum alloy product, such as any of the any of the 1xx-8xx aluminum alloys described in the Aluminum Association document Designations and Chemical Composition Limits for Aluminum Alloys in the Form of Castings and Ingot. The first and/or second predetermined aluminum alloy product may be in any suitable form, such as in the form of ingot, billet, powders, wires, ribbons, and the like. Suitable wrought products (foil, sheet, plate, forgings, extrusions), shape cast products (e.g., die cast products), and additively manufactured products (e.g., 3D printed products) may be produced from the first and/or second predetermined aluminum alloy products.

In some embodiments, the first predetermined aluminum alloy product 232 and/or the second predetermined aluminum alloy product 236 may have a composition consistent with a 1xxx or 1xx aluminum alloy. In some embodiments, the first predetermined aluminum alloy product 232 and/or the second predetermined aluminum alloy product 236 may include an aluminum purity of at least 99.5 wt. % up to 99.999 wt. % aluminum. In some embodiments, the first predetermined aluminum alloy product 232 and/or the second predetermined aluminum alloy product 236 may include an aluminum purity of at least 99.6 wt. % up to 99.999 wt. % aluminum. In some embodiments, the first predetermined aluminum alloy product 232 and/or the second predetermined aluminum alloy product 236 may include an aluminum purity of at least 99.7 wt. % up to 99.999 wt. % aluminum. In some embodiments, the first predetermined aluminum alloy product 232 and/or the second predetermined aluminum alloy product 236 may include an aluminum purity of at least 99.75 wt. % up to 99.999 wt. % aluminum. In some embodiments, the first predetermined aluminum alloy product 232 and/or the second predetermined aluminum alloy product 236 may include an aluminum purity of at least 99.8 wt. % up to 99.999 wt. % aluminum. In some embodiments, the first predetermined aluminum alloy product 232 and/or the second predetermined aluminum alloy product 236 may include an aluminum purity of at least 99.85 wt. % up to 99.999 wt. % aluminum. In some embodiments, the first predetermined aluminum alloy product 232 and/or the second predetermined aluminum alloy product 236 may include an aluminum purity of at least 99.9 wt. % up to 99.999 wt. % aluminum. In some embodiments, the first predetermined aluminum alloy product 232 and/or the second predetermined aluminum alloy product 236 may include an aluminum purity of at least 99.95 wt. % up to 99.999 wt. % aluminum.

In some embodiments, the first predetermined aluminum alloy product 232 and/or the second predetermined aluminum alloy product 236 may have a composition consistent with a 2xxx aluminum alloy.

In some embodiments, the first predetermined aluminum alloy product 232 and/or the second predetermined aluminum alloy product 236 may have a composition consistent with a 3xxx aluminum alloy.

In some embodiments, the first predetermined aluminum alloy product 232 and/or the second predetermined aluminum alloy product 236 may have a composition consistent with a 4xxx aluminum alloy.

In some embodiments, the first predetermined aluminum alloy product 232 and/or the second predetermined aluminum alloy product 236 may have a composition consistent with a 5xxx aluminum alloy.

In some embodiments, the first predetermined aluminum alloy product 232 and/or the second predetermined aluminum alloy product 236 may have a composition consistent with a 6xxx aluminum alloy.

In some embodiments, the first predetermined aluminum alloy product 232 and/or the second predetermined aluminum alloy product 236 may have a composition consistent with a 7xxx aluminum alloy.

In some embodiments, the first predetermined aluminum alloy product 232 and/or the second predetermined aluminum alloy product 236 may have a composition consistent with an 8xxx aluminum alloy.

In some embodiments, the first predetermined aluminum alloy product 232 and/or the second predetermined aluminum alloy product 236 may have a composition consistent with a 2xx aluminum alloy.

In some embodiments, the first predetermined aluminum alloy product 232 and/or the second predetermined aluminum alloy product 236 may have a composition consistent with a 3xx aluminum alloy.

In some embodiments, the first predetermined aluminum alloy product 232 and/or the second predetermined aluminum alloy product 236 may have a composition consistent with a 4xx aluminum alloy.

In some embodiments, the first predetermined aluminum alloy product 232 and/or the second predetermined aluminum alloy product 236 may have a composition consistent with a 5xx aluminum alloy.

In some embodiments, the first predetermined aluminum alloy product 232 and/or the second predetermined aluminum alloy product 236 may have a composition consistent with a 7xx aluminum alloy.

In some embodiments, the first predetermined aluminum alloy product 232 and/or the second predetermined aluminum alloy product 236 may have a composition consistent with an 8xx aluminum alloy.

While the methods described herein are generally directed to purifying aluminum and an aluminum purification cell, the apparatus, system, and methods described herein are applicable to purifying other materials (e.g., magnesium) or to different kinds of cells such as different purification cells (e.g., a magnesium purification cell). In some embodiments, the purification cell includes at least one electrode, such as a cathode or an anode.

While a number of embodiments of the present disclosure have been described, it is understood that these embodiments are illustrative only, and not restrictive, and that many modifications may become apparent to those of ordinary skill in the art. The various steps may be carried out in any desired order (and any desired steps may be added and/or any desired steps may be eliminated). For example, the predetermined aluminum alloy products may be produced by mixing any of the streams described herein (e.g., precursor 242 with purified aluminum stream 214). The exemplary embodiments of purifying aluminum are not meant to be exhaustive. The features and characteristics of the present disclosure may be combined in any manner.

Further, the present disclosure is explained with reference to the attached drawings, wherein like structures are referred to by like numerals throughout the several views. The figures constitute a part of this specification and include illustrative embodiments of the present disclosure and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present disclosure.

Among those benefits and improvements that have been disclosed, other objects and advantages of the present disclosure will become apparent from the following description taken in conjunction with the accompanying figures. Detailed embodiments of the present disclosure are disclosed herein; however, it is to be understood that the disclosed embodiments are merely illustrative of the present disclosure that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.

What is claimed is:

1. A method comprising:
(a) adding a feedstock to an aluminum purification cell, wherein the feedstock comprises aluminum scrap;
(b) purifying the feedstock, thereby producing a purified aluminum stream and a raffinate stream;
(c) separating components of the raffinate stream, thereby producing at least a first byproduct stream and a second byproduct stream; and
(d) mixing at least a portion of the first byproduct stream with at least a portion of a purified aluminum from the purified aluminum stream to produce an aluminum alloy product.

2. The method of claim 1, wherein the feedstock comprises at least 50 wt. % Al, and wherein the feedstock comprises not greater than 5 wt. % alumina (Al₂O₃).

3. The method of claim 2, wherein the aluminum scrap comprises at least 5 wt. % Al of the feedstock.

4. The method of claim 1, wherein the purifying step (b) comprises passing electrical current through at least one anode through an electrolyte and into at least one cathode.

5. The method of claim 1, wherein the purified aluminum stream comprises at least 95 wt. % Al.

6. The method of claim 1, wherein the raffinate stream comprises not greater than 50 wt. % Al.

7. The method of claim 6, wherein the raffinate stream comprises at least 3 wt. % Si.

8. The method of claim 7, wherein the raffinate stream comprises at least 3 wt. % Fe.

9. The method of claim 1, wherein the aluminum alloy product comprises (i) a 1xxx-8xxx aluminum alloy composition, (ii) a 1xx-8xx aluminum alloy composition, or (iii) a combination of (i) and (ii).

10. The method of claim 1, further comprising mixing additional component(s) with the purified aluminum stream.

11. The method of claim 10, wherein the additional component(s) comprise at least one of Si, Fe, Cu, Ce, Cs, Mg, Mn, Cr, Ni, Zn, Ti, Co, Sn, Sr, Li, V, Zr, Sc, and combinations thereof.

12. The method of claim 10, wherein the additional component(s) comprise at least one aluminum scrap alloy, wherein the aluminum scrap alloy is a scrap of an aluminum alloy.

13. The method of claim 1, further comprising adding at least one of the first byproduct stream, the second byproduct stream, and combinations thereof to a precursor stream to produce the feedstock.

14. The method of claim 1, further comprising adding a predetermined metal to a precursor stream to produce the feedstock.

15. The method of claim 14, wherein the predetermined metal is at least one of Si, Fe, Cu, Ce, Cs, Mg, Mn, Cr, Ni, Zn, Ti, Co, Sn, Sr, Li, V, Zr, Sc, and combinations thereof.

16. The method of claim 14, wherein the predetermined metal is at least one of Cu, Ce, Cs, Sn, Zn, and combinations thereof.

17. The method of claim 14, wherein the predetermined metal comprises Cu.

18. The method of claim 1, wherein the first byproduct stream comprise one or more of (a) at least 12 wt. % Si, (b) at least 3 wt. % Mn, (c) at least 3 wt. % Fe.

19. The method of claim 1, wherein the first byproduct stream and/or the second byproduct stream comprises at least 5% of at least one of Si, Mn, Fe, Zn, Cu, and combinations thereof.
